(19) United States
(12) Patent Application Publication
(10) Pub. No.: US 2024/0220648 A1
(43) Pub. Date: Jul. 4, 2024

(54) ORDER-PRESERVING ENCRYPTION METHOD AND APPARATUS

(71) Applicant: ELECTRONICS AND TELECOMMUNICATIONS RESEARCH INSTITUTE, Daejeon (KR)

(72) Inventors: Young-Kyung LEE, Daejeon (KR); Ju-Young KIM, Daejeon (KR); Sung-Jin YU, Daejeon (KR); Nam-Su JHO, Daejeon (KR)

(73) Assignee: ELECTRONICS AND TELECOMMUNICATIONS RESEARCH INSTITUTE, Daejeon (KR)

(21) Appl. No.: 18/462,214

(22) Filed: Sep. 6, 2023

(30) Foreign Application Priority Data
Dec. 29, 2022 (KR) 10-2022-0188599

(51) Int. Cl. G06F 21/62; G06F 21/60

(52) U.S. Cl. CPC G06F 21/6227; G06F 21/602

(57) ABSTRACT

Disclosed herein are an order-preserving encryption method and apparatus. The order-preserving encryption method may include when plaintext data is received from a client, storing a ciphertext database (DB), generated by encrypting the plaintext data, and a search index in a server, when a request for a range search query is received from the client, converting the range search query into a search index query statement, querying the server including search indices for the search index query statement, and querying the ciphertext DB of the server for an index ciphertext received in response to the query, and decrypting a ciphertext received as a response from the ciphertext DB and then transferring a plaintext-type response to the query statement to the client.

### CROSS REFERENCE TO RELATED APPLICATION

This application claims the benefit of Korean Patent Application No. 10-2022-0188599, filed Dec. 29, 2022, which is hereby incorporated by reference in its entirety into this application.

### BACKGROUND OF THE INVENTION

### 1. Technical Field

The present disclosure relates to an order-preserving encryption method and apparatus, which search for encrypted data.

### 2. Description of the Related Art

With the activation of data-based industries and the proliferation of cloud environments, the importance of data protection is being emphasized more than ever. Although utilizing traditional encryption-based database information protection technology can provide a high level of security, the convenience of accessing encrypted data tends to be decreased by that much. In other words, when a query search for finding only desired data in an encrypted database is performed, it is necessary to decrypt the entire encrypted database and conduct the search in order to obtain accurate query and response. The deterioration of efficiency attributable to encryption/decryption performed for data protection may become a serious problem as the size of data becomes larger.

To address similar problems including the above-described problem, research into and development of encryption techniques capable of providing both data protection and usability are conducted. Representative examples of the encryption techniques include homomorphic encryption which allows computations to be performed in an encrypted state, searchable encryption, order-preserving encryption, etc., which are modern encryption research fields.

Order-Preserving Encryption (OPE) refers to an encryption technique in which, when pieces of data that can be compared for their sizes are encrypted, ciphertexts thereof can also be compared for their sizes, and in which the order of the sizes of the pieces of data before being encrypted is preserved.

A conventional order-preserving encryption technique has proposed a technique in which state information is separately stored in such a way that sensitive state information is stored in a client and less sensitive state information for encoding management is stored in a server, thus decreasing the amount of information stored in the client while improving temporal efficiency. However, such a technique has an inefficient aspect because a tree configuration is complicated for encoding assignment and change in an encoding value stored in a database frequently occurs.

### SUMMARY OF THE INVENTION

Accordingly, the present disclosure has been made keeping in mind the above problems occurring in the prior art, and an object of the present disclosure is to provide an order-preserving encryption method and apparatus, which can improve temporal efficiency while improving security.

In accordance with an aspect of the present disclosure to accomplish the above object, there is provided an order-preserving encryption method, including when plaintext data is received from a client, storing a ciphertext database (DB), generated by encrypting the plaintext data, and a search index in a server, when a request for a range search query is received from the client, converting the range search query into a search index query statement, querying the server including search indices for the search index query statement, and querying the ciphertext DB of the server for an index ciphertext received in response to the query, and decrypting a ciphertext received as a response from the ciphertext DB and then transferring a plaintext-type response to the query statement to the client.

The plaintext type may include an encryption target table including an index attribute and a data attribute.

The order-preserving encryption method may further include generating a table including an index attribute and a data ciphertext attribute by encrypting the data attribute in the encryption target table using a probabilistic symmetric key algorithm, and storing the generated table in the server.

The order-preserving encryption method may further include when a record that is an encryption target is given, adding the record to a frequency table including an encrypted data attribute and a frequency attribute.

The frequency table may be configured such that pieces of data are aligned in an order of size.

A position value indicating a position of data, added to the frequency table, in the order of size may be calculated using the frequency table.

The order-preserving encryption method may further include calculating the position of the added data in the order of size in such a way as to calculate a minimum value of the position of the added data in the order of size by summing frequencies of each piece of data smaller than the added data, to randomly select a value smaller than a frequency of data identical to the added data, and to add the minimum value of the position to the randomly selected value.

The order-preserving encryption method may further include storing a value, obtained by encrypting an index of the added data using a probabilistic symmetric key algorithm, at a position of a ciphertext list in the order of size, and when index ciphertexts are stored in the ciphertext list in an order of a data size, performing encoding such that differences between encoding values are equal to each other and become a value that is less than a predesignated value and greater than 0.

The order-preserving encryption method may further include constructing a table from the index ciphertexts and the encoding values, and storing the table as a search index in the server.

The order-preserving encryption method may further include calculating position values of pieces of data in the order of size using the frequency table, and querying an index table of the server for an index ciphertext corresponding to an encoding size based on the encoding size.

In accordance with another aspect of the present disclosure to accomplish the above object, there is provided an order-preserving encryption apparatus, including memory configured to store a control program for order-preserving encryption, and a processor configured to execute the control program stored in the memory, wherein the processor is configured to, when plaintext data is received from a client, store a ciphertext database (DB), generated by encrypting the plaintext data, and a search index in a server, when a request for a range search query is received from the client, convert the range search query into a search index query statement, query the server including search indices for the search index query statement and query the ciphertext DB of the server for an index ciphertext received in response to the query, decrypt a ciphertext received as a response from the ciphertext DB and then transfer a plaintext-type response to the query statement to the client.

The plaintext type may include an encryption target table including an index attribute and a data attribute.

The processor may be configured to generate a table including an index attribute and a data ciphertext attribute by encrypting the data attribute in the encryption target table using a probabilistic symmetric key algorithm, and to store the generated table in the server.

The processor may be configured to, when a record that is an encryption target is given, add the record to a frequency table including an encrypted data attribute and a frequency attribute.

The frequency table may be configured such that pieces of data are aligned in an order of size.

A position value indicating a position of data, added to the frequency table, in the order of size may be calculated using the frequency table.

The processor may be configured to calculate the position of the added data in the order of size in such a way as to calculate a minimum value of the position of the added data in the order of size by summing frequencies of each piece of data smaller than the added data, to randomly select a value smaller than a frequency of data identical to the added data, and to add the minimum value of the position to the randomly selected value.

The processor may be configured to store a value, obtained by encrypting an index of the added data using a probabilistic symmetric key algorithm, at a position of a ciphertext list in the order of size, and when index ciphertexts are stored in the ciphertext list in an order of a data size, perform encoding such that differences between encoding values are equal to each other and become a value that is less than a predesignated value and greater than 0.

The processor may be configured to construct a table from the index ciphertexts and the encoding values and store the table as a search index in the server.

The processor may be configured to calculate position values of pieces of data in the order of size using the frequency table, and query an index table of the server for an index ciphertext corresponding to an encoding size based on the encoding size.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating an order-preserving encryption system according to an embodiment;

FIG. 2 is a block diagram illustrating the server configuration of an order-preserving encryption system according to an embodiment;

FIG. 3 is a diagram illustrating encryption target data according to an embodiment;

FIG. 4 is a diagram illustrating a process of encrypting a record in a search index generation process according to an embodiment;

FIG. 5 is a diagram illustrating a process of adding data to a frequency table in the search index generation process according to an embodiment;

FIG. 6 is a diagram illustrating a process of aligning pieces of data at positions in the order of size in the search index generation process according to an embodiment;

FIG. 7 is a diagram illustrating a process of adding ciphertexts to positions in the order of size in a ciphertext list in the search index generation process according to an embodiment;

FIG. 8 is a diagram illustrating a query search process according to an embodiment;

FIG. 9 is a flowchart illustrating an order-preserving encryption method according to an embodiment; and

FIG. 10 is a block diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Embodiments of the present disclosure will now be described in detail with reference to the accompanying drawings. Like numerals refer to like elements throughout, and overlapping descriptions will be omitted.

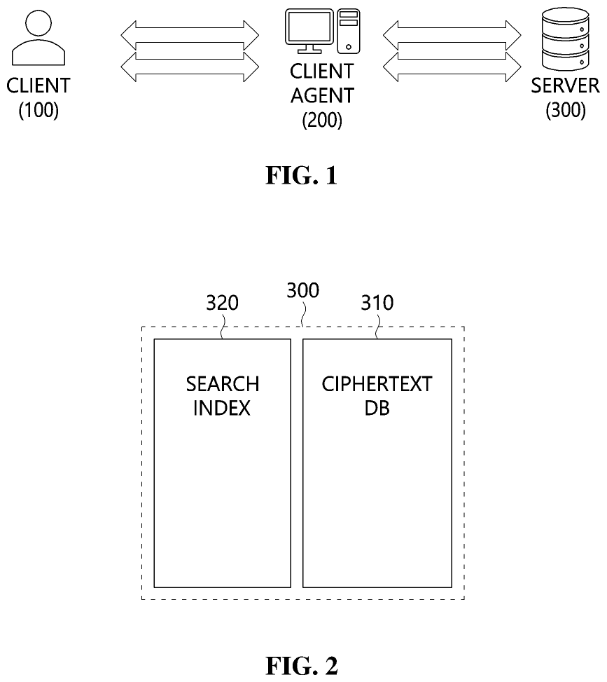

FIG. 1 is a block diagram illustrating an order-preserving encryption system according to an embodiment, and FIG. 2 is a block diagram illustrating the server configuration of an order-preserving encryption system according to an embodiment.

Referring to FIG. 1, the order-preserving encryption system may include a client 100, a client agent 200, and a server 300.

The client 100 may perform insertion of pieces of data, the sizes of which can be compared, determination of equivalence between the pieces of data, and a range search for the pieces of data on the server 300. The client agent 200 may function as an intermediary for encrypting the pieces of data and storing the encrypted data in the server 300 and for assisting a search for the encrypted data in the server 300. The server 300 may provide a storage function and a query-response function.

The client agent 200 may be an apparatus for order-preserving encryption. The client agent 200 may perform two functions in response to a request received from the client 100.

When plaintext data is received from the client 100 through data insertion, the client agent 200 may encrypt the data using a private key, and may store a ciphertext database (DB) 310, generated through encryption, and a search index 320 in the server 300, as illustrated in FIG. 2.

When an equivalence query or a range query is received from the client 100 through a search query-response, the client agent 200 may convert the received query into a query statement for efficiency query processing, make a query to the server 300, decrypt a ciphertext received as a response, and transfer a plaintext response to the query statement to the client 100.

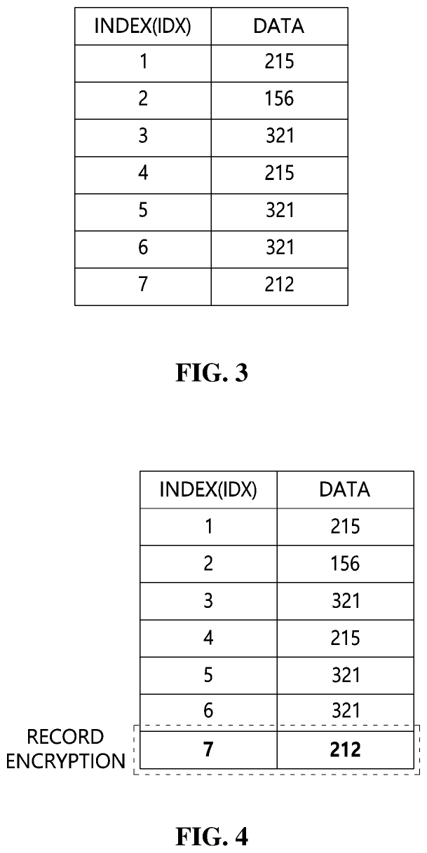

FIG. 3 is a diagram illustrating encryption target data according to an embodiment.

As illustrated in FIG. 3, encryption target data according to an embodiment is a table composed of one index attribute and data attributes, which allow redundancy and the sizes of which can be compared. The table may be encrypted in units of records, and may be operated in such a way as to perform, in the case of a search, an equivalence query and a range query on the data attributes and to provide the index and data of the corresponding record as a response.

An encryption process presented in the present disclosure will be described below. The encryption process may include a ciphertext DB generation process and an index generation process. A ciphertext DB generation process may be performed to encrypt only a data portion in an encryption target table using a probabilistic symmetric key algorithm (e.g., AES-CBC), generate a table composed of an index attribute and data ciphertext attributes, and store the table in a DB server.

A search index generation process according to an embodiment will be described below with reference to FIGS. 4 to 7.

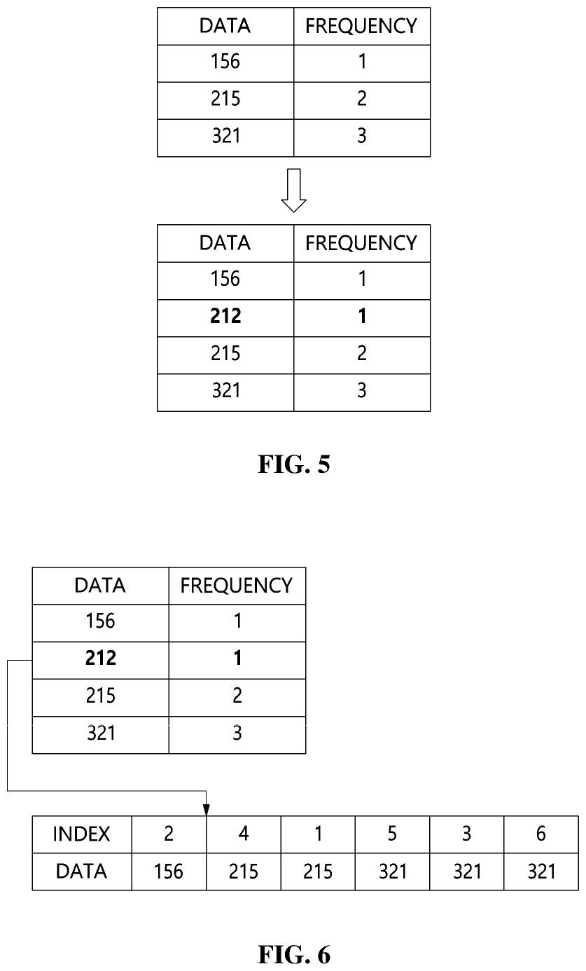

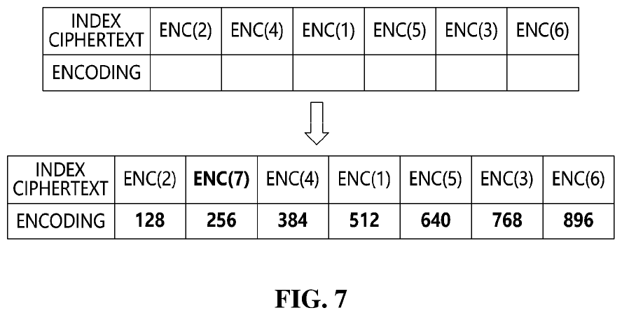

FIG. 4 is a diagram illustrating a process of encrypting a record in a search index generation process according to an embodiment, FIG. 5 is a diagram illustrating a process of adding data to a frequency table in the search index generation process according to an embodiment, FIG. 6 is a diagram illustrating a process of aligning pieces of data at positions in the order of size in the search index generation process according to an embodiment, and FIG. 7 is a diagram illustrating a process of adding ciphertexts to positions in the order of size in a ciphertext list in the search index generation process according to an embodiment.

As illustrated in FIG. 4, when a record that is an encryption target is given, data may be added to a frequency table composed of previously encrypted data and frequency thereof as attributes. As illustrated in FIG. 5, the frequency table may be managed such that pieces of data are aligned in ascending order.

As illustrated in FIG. 6, when pieces of data are enumerated in the order of size in consideration of data redundancy, a position value indicating the position of added data in the order of size may be calculated using the frequency table. The method may probabilistically calculate the position of the added data in the order of size in such a way as to calculate the minimum value of the position of the added data in the order of size by summing the frequencies of each piece of data smaller than the added data, to randomly select a value smaller than the frequency of the same data as the added data, and to add the minimum value of the position to the randomly selected value.

As illustrated in FIG. 7, a value obtained by encrypting the index of the added data using a probabilistic symmetric key encryption algorithm may be stored at the above-calculated position of a ciphertext list in the order of size.

When all index ciphertexts are stored in the list in the order of size, encoding values may be assigned such that the differences between encoding values are equal to each other and become a value that is less than a designated value and greater than 0.

When encoding values are additionally inserted into the server to which encoding values are already assigned, the difference between encoding values is equally divided by the number of pieces of data to be newly inserted, and resulting values are assigned.

When the case where encoding cannot be performed due to an encoding value difference of less than 1 occurs, encoding values only need to be reassigned to the entire data according to the initial scheme. The encoding values assigned in this way may preserve the order of the sizes of pieces of data, and encoding values may be different from each other for the same data.

The frequency table generated through the order-preserving encryption process according to an embodiment may be stored as sensitive state information in client storage, and may be managed by the client agent. A table may be constructed form the generated index ciphertexts and encoding values, and may be stored as search indices in the server.

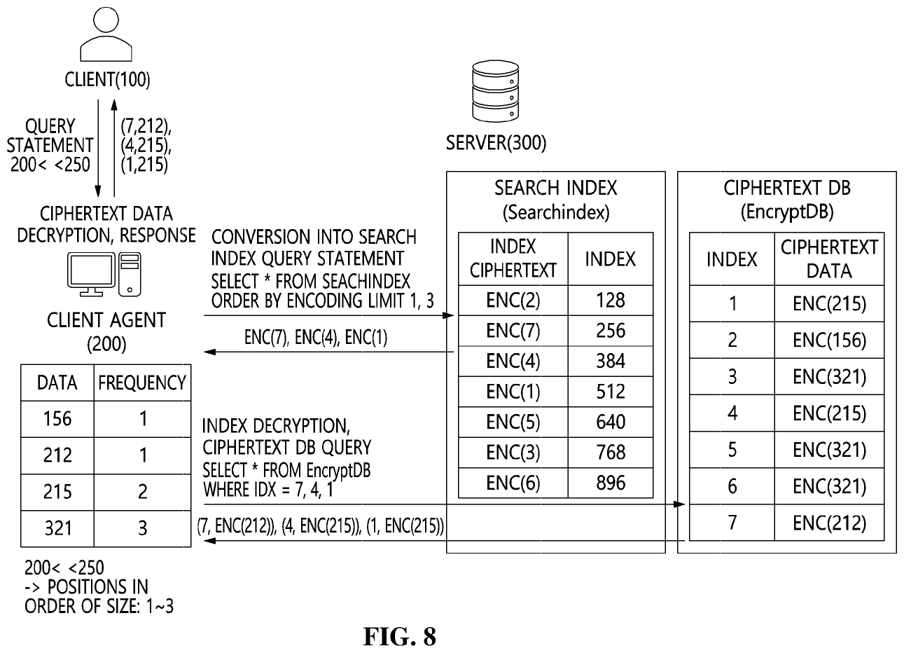

FIG. 8 is a diagram illustrating a query search process according to an embodiment.

As illustrated in FIG. 8, the client 100 may request the client agent 200 to perform an equivalence search query or a range search query. The client agent 200 may calculate the position values of pieces of data corresponding to query results in the order of size by utilizing the frequency table stored in the client storage, and may query the server 300 including search indices for an index ciphertext corresponding to an encoding size based on the encoding size.

The client agent 200 may decrypt the index ciphertext received from the server 300 in response to the query. The client agent 200 may query the ciphertext DB (i.e., encrypt DB) of the server 300 for ciphertext data of the corresponding index.

The client agent 200 may decrypt the index ciphertext received from the server 300 in response to the query, and may transfer the decrypted index ciphertext to the client 100.

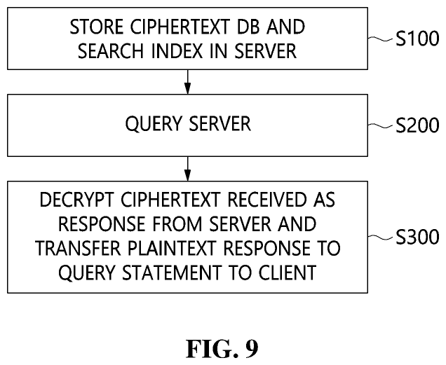

FIG. 9 is a flowchart illustrating an order-preserving encryption method according to an embodiment.

As illustrated in FIG. 9, the order-preserving encryption method according to an embodiment may include step S100 of encrypting plaintext data and then storing a ciphertext DB and a search index in a server, step S200 of, when a query for a range search is received from a client, querying the server for the range search, and step S300 of transferring a response to the query to the client.

The order-preserving encryption method according to the embodiment may be performed by an order-preserving encryption apparatus. The order-preserving encryption apparatus may be a client agent.

The order-preserving encryption apparatus may receive the plaintext data from the client. The order-preserving encryption apparatus may encrypt the plaintext data and then generate a ciphertext DB and a search index, and may store the generated ciphertext DB and the search index in the server at step S100.

The order-preserving encryption apparatus may receive a request for the range search query from the client. The order-preserving encryption apparatus may convert the range search query into a search index query statement, and may query the server including search indices for the query statement. The order-preserving encryption apparatus may query the ciphertext DB based on the ciphertext received from the server in response to the query at step S200.

The order-preserving encryption apparatus may receive the ciphertext from the server. The order-preserving encryption apparatus may decrypt the ciphertext. The order-preserving encryption apparatus may transfer a plaintext response to the query statement to the client at step S300.

The order-preserving encryption presented in the embodiment has evolved from an indistinguishability under an ordered chosen plaintext attack (IND-OCPA) model that is a high security model, and may be securely designed in an indistinguishability under frequency analyzing ordered chosen-plaintext attack (IND-FAOCPA) model in which data redundancy is taken into consideration, thus providing high security. Simply, IND-OCPA may be simplified without exposing the number of times that data is repeated through an order-preserving encrypted ciphertext set. Variable sequence-preserving encryption proposed in the present disclosure allows only sensitive state information for encoding management to be managed by the client, thus providing temporally efficient insertion and search functions. Further, the amount of data stored in the client may be more efficient as more data redundancy occurs. In particular, the variable order-preserving encryption is an efficient client storage order-preserving encryption technique having a lower encoding change frequency because encoding values are assigned at one time after all of index ciphertexts of pieces of data to be inserted are enumerated in the order of size, rather than a technique for assigning and storing an encoding value whenever data is inserted.

The order-preserving encryption apparatus according to the embodiment may be implemented in a computer system such as a computer readable storage medium.

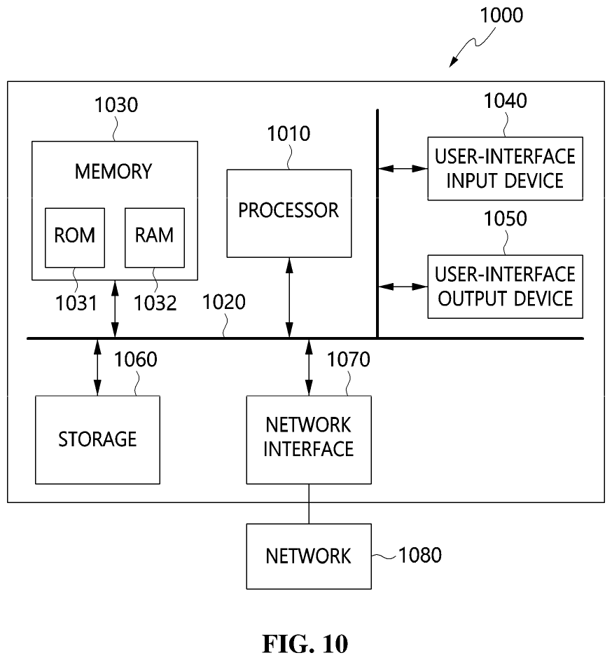

FIG. 10 is a block diagram illustrating the configuration of a computer system according to an embodiment.

Referring to FIG. 10, a computer system 1000 according to an embodiment may include one or more processors 1010, memory 1030, a user interface input device 1040, a user interface output device 1050, and storage 1060, which communicate with each other through a bus 1020. The computer system 1000 may further include a network interface 1070 connected to a network 1080.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the order-preserving encryption apparatus.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an Application-Specific Integrated Circuit (ASIC), a Field-Programmable Gate Array (FPGA), etc., without being limited thereto.

The memory 1030 may store various types of data for the overall operation such as a control program for performing an order-preserving encryption method according to an embodiment. In detail, the memory 1030 may store multiple applications executed by the order-preserving encryption apparatus, and data and instructions for the operation of the order-preserving encryption apparatus.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

In accordance with an embodiment, a computer-readable storage medium for storing a computer program may include instructions enabling the processor to perform a method including an operation of, when plaintext data is received from a client, storing a ciphertext database (DB), generated by encrypting the plaintext data, and a search index in a server, an operation of, when a request for a range search query is received from the client, converting the range search query into a search index query statement, querying the server including search indices for the search index query statement, and querying the ciphertext DB of the server for an index ciphertext received in response to the query, and an operation of decrypting a ciphertext received as a response from the ciphertext DB and then transferring a plaintext-type response to the query statement to the client.

In accordance with an embodiment, a computer program stored in a computer-readable storage medium may include instructions enabling the processor to perform a method including an operation of, when plaintext data is received from a client, storing a ciphertext database (DB), generated by encrypting the plaintext data, and a search index in a server, an operation of, when a request for a range search query is received from the client, converting the range search query into a search index query statement, querying the server including search indices for the search index query statement, and querying the ciphertext DB of the server for an index ciphertext received in response to the query, and an operation of decrypting a ciphertext received as a response from the ciphertext DB and then transferring a plaintext-type response to the query statement to the client.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

The order-preserving encryption method according to the embodiment is securely designed in consideration of data redundancy, thus obtaining high security.

Further, the embodiments may enumerate index ciphertexts of data in the order of size and thereafter assign encoding values to the index ciphertexts at one time, thus decreasing the frequency with which encoding is changed.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. An order-preserving encryption method, comprising:
when plaintext data is received from a client, storing a ciphertext database (DB), generated by encrypting the plaintext data, and a search index in a server;
when a request for a range search query is received from the client, converting the range search query into a search index query statement, querying the server including search indices for the search index query statement, and querying the ciphertext DB of the server for an index ciphertext received in response to the query; and
decrypting a ciphertext received as a response from the ciphertext DB and then transferring a plaintext-type response to the query statement to the client.

2. The order-preserving encryption method of claim 1, wherein the plaintext type includes an encryption target table including an index attribute and a data attribute.

3. The order-preserving encryption method of claim 2, further comprising:
generating a table including an index attribute and a data ciphertext attribute by encrypting the data attribute in the encryption target table using a probabilistic symmetric key algorithm, and storing the generated table in the server.

4. The order-preserving encryption method of claim 3, further comprising:
when a record that is an encryption target is given, adding the record to a frequency table including an encrypted data attribute and a frequency attribute.

5. The order-preserving encryption method of claim 4, wherein the frequency table is configured such that pieces of data are aligned in an order of size.

6. The order-preserving encryption method of claim 5, wherein a position value indicating a position of data, added to the frequency table, in the order of size is calculated using the frequency table.

7. The order-preserving encryption method of claim 6, further comprising:
calculating the position of the added data in the order of size in such a way as to calculate a minimum value of the position of the added data in the order of size by summing frequencies of each piece of data smaller than the added data, to randomly select a value smaller than a frequency of data identical to the added data, and to add the minimum value of the position to the randomly selected value.

8. The order-preserving encryption method of claim 7, further comprising:
storing a value, obtained by encrypting an index of the added data using a probabilistic symmetric key algorithm, at a position of a ciphertext list in the order of size; and
when index ciphertexts are stored in the ciphertext list in an order of a data size, performing encoding such that differences between encoding values are equal to each other and become a value that is less than a predesignated value and greater than 0.

9. The order-preserving encryption method of claim 8, further comprising:
constructing a table from the index ciphertexts and the encoding values, and storing the table as a search index in the server.

10. The order-preserving encryption method of claim 1, further comprising:
calculating position values of pieces of data in the order of size using the frequency table, and querying an index table of the server for an index ciphertext corresponding to an encoding size based on the encoding size.

11. An order-preserving encryption apparatus, comprising:
a memory configured to store a control program for order-preserving encryption; and
a processor configured to execute the control program stored in the memory, wherein the processor is configured to, when plaintext data is received from a client, store a ciphertext database (DB), generated by encrypting the plaintext data, and a search index in a server, when a request for a range search query is received from the client, convert the range search query into a search index query statement, query the server including search indices for the search index query statement and query the ciphertext DB of the server for an index ciphertext received in response to the query, decrypt a ciphertext received as a response from the ciphertext DB and then transfer a plaintext-type response to the query statement to the client.

12. The order-preserving encryption apparatus of claim 11, wherein the plaintext type includes an encryption target table including an index attribute and a data attribute.

13. The order-preserving encryption apparatus of claim 12, wherein the processor is configured to generate a table including an index attribute and a data ciphertext attribute by encrypting the data attribute in the encryption target table using a probabilistic symmetric key algorithm, and to store the generated table in the server.

14. The order-preserving encryption apparatus of claim 13, wherein the processor is configured to, when a record that is an encryption target is given, add the record to a frequency table including an encrypted data attribute and a frequency attribute.

15. The order-preserving encryption apparatus of claim 14, wherein the frequency table is configured such that pieces of data are aligned in an order of size.

16. The order-preserving encryption apparatus of claim 15, wherein a position value indicating a position of data, added to the frequency table, in the order of size is calculated using the frequency table.

17. The order-preserving encryption apparatus of claim 16, wherein the processor is configured to calculate the position of the added data in the order of size in such a way as to calculate a minimum value of the position of the added data in the order of size by summing frequencies of each piece of data smaller than the added data, to randomly select a value smaller than a frequency of data identical to the added data, and to add the minimum value of the position to the randomly selected value.

18. The order-preserving encryption apparatus of claim 17, wherein the processor is configured to store a value, obtained by encrypting an index of the added data using a probabilistic symmetric key algorithm, at a position of a ciphertext list in the order of size, and when index ciphertexts are stored in the ciphertext list in an order of a data size, perform encoding such that differences between encoding values are equal to each other and become a value that is less than a predesignated value and greater than 0.

19. The order-preserving encryption apparatus of claim 18, wherein the processor is configured to construct a table from the index ciphertexts and the encoding values, and store the table as a search index in the server.

20. The order-preserving encryption apparatus of claim 11, wherein the processor is configured to calculate position values of pieces of data in the order of size using the frequency table, and query an index table of the server for an index ciphertext corresponding to an encoding size based on the encoding size.
